(19) United States
(12) Patent Application Publication
(10) Pub. No.: US 2026/0081919 A1
(43) Pub. Date: Mar. 19, 2026

(54) CUSTOMIZED FINGERPRINTING ASSOCIATED WITH USER DEVICE ACTIVITY

(71) Applicant: Wells Fargo Bank, N.A., San Francisco, CA (US)

(72) Inventors: Nicholas Gillis, Martinsburg, WV (US); Basil F. Nimry, West Des Moines, IA (US)

(21) Appl. No.: 18/888,856

(22) Filed: Sep. 18, 2024

(51) Int. Cl. H04L 9/40

(52) U.S. Cl. CPC H04L 63/0876; H04L 63/1441

(57) ABSTRACT

This disclosure describes techniques for performing fingerprinting of network devices, where the fingerprinting is capable of providing a high definition and clear picture of the network device and/or the identity of the operator of the network device. In one example, this disclosure describes a method that includes receiving, over a network from a user device, a first set of fingerprint data; generating, based on the first set of fingerprint data, a first threat assessment associated with the user; receiving, over the network from the user device, a second set of fingerprint data; generating, by the computing system and based on the first set of fingerprint data and the second set of fingerprint data, a second threat assessment; and sending, by the computing system and based on the second threat assessment, control signals to a system on the network to cause the system to implement a policy threat mitigation policy.

### TECHNICAL FIELD

This disclosure relates to networked computing systems, and more specifically, to techniques for making a threat assessment for one or more network devices.

### BACKGROUND

Device fingerprinting involves attempting to uniquely identify a device, often while that device is connected to a network and operated by a user. User or device fingerprinting can play a role in both fraud detection and prevention (e.g., identifying devices used to perpetuate fraud) as well as user experience personalization (e.g., tailoring content to a user).

Fingerprinting typically involves collecting information about a user device, which may include hardware attributes, software configurations, network properties, and user behavior. Hardware attributes might include information about the device's processor type, memory, screen resolution, and device model. Software configurations may involve software-related attributes like the browser version, installed plugins and extensions, time zone settings, and language preferences. Network properties may include the device's IP address, Internet service provider, and location. User behavior might involve typing speed, mouse movements, touchscreen gestures, and browsing habits.

### SUMMARY

This disclosure describes techniques for performing fingerprinting of network devices, where the fingerprinting is capable of providing a high definition and clear picture of the network device and/or the identity of the operator of the network device. As described herein, the disclosed techniques involve enabling a sequence of fingerprint information to be captured for a user device during a session or over the course of a user experience, possibly encompassing most or all of such a timeframe. The sequence of fingerprint information can be analyzed to determine whether the user or user device is operating as expected and is behaving normally. In some examples, the fingerprint information collected from a user device interacting with a network service may be compared to historical fingerprinting information captured during prior interactions with the network service. Based on the analysis and/or comparison, a threat level may be assigned to the user or to the user device.

In some cases, precautionary, preventative, and/or remediation actions may be taken in response to threat levels that are sufficiently high. Such actions may involve limiting a user device's access to certain network services or other resources. In some cases, where a sufficient number of user devices are identified as having a high threat level, precautionary, preventative, and/or remediation actions may be taken across a wider subset of user devices (or all user devices), possibly including devices that have not been individually assessed as having a high threat level.

In some examples, this disclosure describes operations performed by a computing system in accordance with one or more aspects of this disclosure. In one specific example, this disclosure describes a method comprising receiving, by a computing system and over a network from a user device, a first set of fingerprint data, wherein the first set of fingerprint data reflects operations performed by the user device before a network service system authenticates a user of the user device; generating, by the computing system and based on the first set of fingerprint data, a first threat assessment associated with the user; receiving, by the computing system, and over the network from the user device, a second set of fingerprint data, wherein the second set of fingerprint data reflects operations performed by the user device after the network service system authenticates the user of the user device; generating, based on the first set of fingerprint data and the second set of fingerprint data, a second threat assessment; and sending, by the computing system and based on the second threat assessment, control signals to a system on the network to cause the system to implement a policy threat mitigation policy.

In another example, this disclosure describes a system comprising a storage system and processing circuitry having access to the storage system, wherein the processing circuitry is configured to carry out operations described herein. In yet another example, this disclosure describes a computer-readable storage medium comprising instructions that, when executed, configure processing circuitry of a computing system to carry out operations described herein.

The details of one or more examples of the disclosure are set forth in the accompanying drawings and the description herein. Other features, objects, and advantages of the disclosure will be apparent from the description and drawings, and from the claims.

### BRIEF DESCRIPTION OF THE DRAWINGS

FIG. 1 is a conceptual diagram illustrating an example system for performing fingerprinting and analysis, in accordance with one or more aspects of the present disclosure.

FIG. 2 is a conceptual diagram illustrating how information about a user device may be collected prior to and during an authenticated session, in accordance with one or more aspects of the present disclosure.

FIG. 3 is a block diagram illustrating an example system for performing fingerprinting and analysis, in accordance with one or more aspects of the present disclosure.

FIG. 4 is a flow diagram illustrating operations performed by an example fingerprinting system, in accordance with one or more aspects of the present disclosure.

Although the above-described Figures are referenced herein in connection with the description of one or more specific examples, such examples are merely illustrative, and each Figure can be used to provide support for other examples not specifically described herein. Accordingly, the one or more examples described herein with reference to any of the above-described Figures should not be construed to narrow the scope or spirit of the subject matter illustrated or otherwise disclosed herein.

### DETAILED DESCRIPTION

This disclosure describes collecting fingerprint information for users and/or user devices that may access network service systems over a public or private network. In some cases, the fingerprint information is used to develop profiles for users or user devices. Such fingerprinting profiles may be used for a number of purposes, including for securing a network, network service systems, or resources available on the network. Such fingerprinting profiles may also be used for preventing unauthorized access to or malicious activity associated with a network or network resources.

This disclosure also describes an application, applet, plug-in, web page, or other executable code that may be deployed to user devices and used to collect information to generate the series of fingerprint data associated with the user device. The series of fingerprint data may be analyzed and used to generate threat assessments. Based on threat assessments made for various users or user devices, a computing system and/or network administrator may take actions to enforce security policies on the network. In at least some examples, such security policies may serve to prevent, mitigate, or remediate unauthorized and/or harmful activity that might otherwise occur on the network.

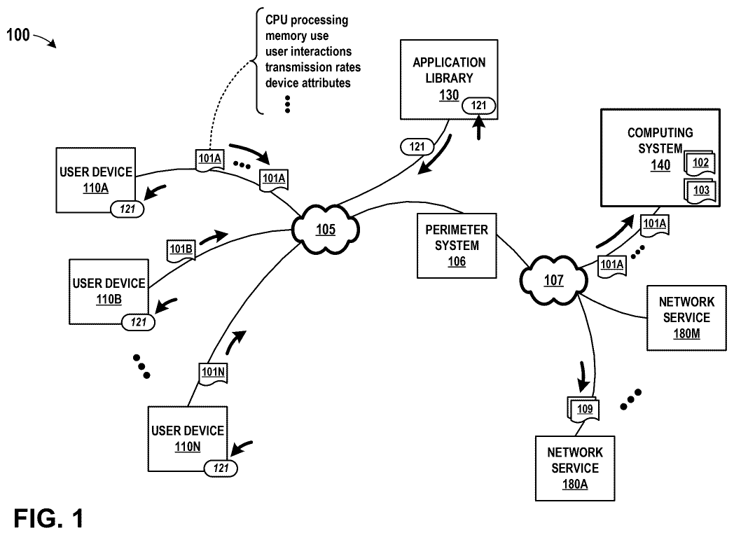

FIG. 1 is a conceptual diagram illustrating an example system for performing fingerprinting and analysis, in accordance with one or more aspects of the present disclosure. System 100 of FIG. 1 illustrates network 105 and private network 107. User devices 110A through 110N (“user devices 110”) and application library system 130 are connected to network 105. Computing system 140 and network service systems 180A through 180M (“network service systems 180”) are connected to private network 107. Perimeter system 106 may act as a gateway between network 105 and private network 107. In some examples, perimeter system 106 may be part of private network 107, and may be a firewall, gateway, or other security perimeter system that provides perimeter protection to private network 107.

Network 105 may be a public network, such as the Internet. Private network 107 may have access to and may be accessible to network 105 through perimeter system 106. Although described as a private network, private network 107 may be any other appropriate type of network, including a cloud network, a virtual network, or otherwise. In some examples, private network 107 may be or may include an enterprise network. In other examples, private network 107 may provide public access to certain systems on private network 107 (e.g., one or more of network service systems 180), making such systems publicly accessible to devices (e.g., user devices 110) over network 105. Even if publicly accessible, each of network service systems 180 may require user devices 110 to successfully authenticate prior to being granted access to certain services provided by a given network service system 180.

The arrangement of various systems and networks illustrated in FIG. 1 is merely an example, and in some situations, one or more of the systems or devices shown in FIG. 1 might be alternatively (or additionally) connected to a different network than shown in FIG. 1. For example, although library system 130 is shown as being primarily connected to network 105, in other examples, library system 130 may be part of private network 107. Similarly, although network service systems 180 are shown as being primarily connected to private network 107, in other examples, one or more of network service systems 180 may be part of and/or directly connected to network 105.

Private network 107 may be operated, owned, or controlled by a business, entity, organization, or bank (hereinafter “organization”). In typical examples, computing system 140 is also operated, owned, or controlled by the organization, as is one or more of network service systems 180. As described herein, computing system 140 may perform threat assessment operations based on various fingerprint data 101 received from each of user devices 110. In some examples, computing system 140 may perform actions in response to those threat assessments, which may be preventative, precautionary, remediation, or other actions.

As described herein, user device 110 is typically a device operated by a user, where the user may be a customer of the organization, and where one or more of network service systems 180 provides support to customers of the organization. For instance, where the organization is a bank, one or more of network service systems 180 may provide banking services to a customers that access each such network service system 180 through a user device 110. Such banking services may involve providing access to customer account, balance, or transaction information, enabling funds transfers, performing other account services, and/or performing other services.

Alternatively, or in addition, each of user devices 110 may be operated by an employee or other agent of the organization. In such an example, where users of user devices 110 are employees or agents of the organization, one or more of network service systems 180 may provide services that enable an employee or agent to perform a job or function to further the mission of the organization. Such activities may include accessing secure systems, performing communication services, designing content or creative works, and/or managing business functions or transactions. Although users of user devices 110 may primarily be described herein as customers, employees, or agents, users of user device 110 need not be limited to such characterizations.

Each of user devices 110 may be implemented by any suitable computing device or system, including a mobile, non-mobile, wearable, and/or non-wearable computing device. Each of user devices 110 is often a mobile phone or tablet, or a laptop or desktop computing device. However, many other possible user devices 110 may be used to perform techniques described herein, and such devices may include a computerized watch, a computerized glove or gloves, a personal digital assistant, a virtual assistant, a gaming system, a media player, an e-book reader, a television or television platform, a bicycle, automobile, or navigation, information and/or entertainment system for a bicycle, automobile or other vehicle, or any other type of wearable, non-wearable, mobile, or non-mobile computing device that may perform operations in accordance with one or more aspects of the present disclosure.

Each user device 110 may be capable of executing application 121, which may be a downloadable application that executes as a desktop application (e.g., on a desktop or laptop device) or as a mobile device application or “app” (e.g., on a mobile device). Application 121 may also be delivered to user devices 110 through a web page downloaded and hosted by a browser. In such an example, application 121 may be an application embedded into a web page (e.g., implemented through JavaScript) that may execute within a browser on any appropriate device (e.g., desktop, laptop, mobile device).

In some examples, application 121 has been developed by the organization, and information about how application 121 operates and is designed to operate is well known to the organization. Computing system 140 may also have access to information about how application 121 operates and is designed to operate, particularly if computing system 140 is also operated, owned, controlled by the organization.

Library system 130 may be a computing system that serves as a repository for applications, such as application 121. In some examples, library system 130 may serve as a marketplace for mobile applications that may execute on a mobile device (e.g., iOS, Android, or other devices). In some examples, library system 130 may enable user devices 110 to choose, download, and install various applications developed for use with user devices 110. In some cases, library system 130 may offer some level of trust verification and/or reliability and integrity testing for applications available at library system 130, particularly if library system 130 is owned or controlled by a trusted platform developer or other third-party organization.

Computing system 140, library system 130, and network service systems 180, as well as any other device that may be illustrated or described in connection with FIG. 1, may be implemented through any suitable computing system. Such computing systems may include one or more server computers, workstations, appliances, cloud computing systems, mainframes, and/or other computing devices that may be capable of performing operations and/or functions described in accordance with one or more aspects of the present disclosure. In other examples, such computing systems may represent or be implemented through one or more virtualized compute instances (e.g., virtual machines, containers) of a data center, cloud computing system, server farm, and/or server cluster.

In operation, and in accordance with one or more aspects of the present disclosure, user device 110A may install an application. For instance, in an example that can be described with reference to FIG. 1, user device 110A detects input corresponding to a request to install an application. User device 110A outputs a signal over network 105. Library system 130 detects the signal over network 105 and determines that the signal is a request to install application 121 at user device 110A. Library system 130 outputs an application installation package over network 105. User device 110A receives the application installation package over network 105 and uses it to install application 121 at user device 110A.

User device 110A may start executing application 121. For instance, again with reference to FIG. 1, and some period of time after application 121 has been installed at user device 110A (e.g., minutes, hours, days, or months after installation), user device 110A detects input that it interprets as a command to start executing application 121. User device 110A loads application 121 into memory and starts executing the application. Application 121 begins performing functions associated with initiating execution at user device 110A. Such functions may include loading data into memory, commencing startup routines, rendering user interface objects to present a user interface, transmitting data over network 105, receiving interactions from a user of user device 110A, and other functions.

Application 121 may perform an authentication procedure. For instance, when starting execution at user device 110A, application 121 may also seek to authenticate a user of user device 110A to ensure that the user is authorized to interact with one or more supporting services relied upon by application 121. In one example, application 121 executing at user device 110A may rely on certain services provided by network service system 180A. Accordingly, the user of user device 110A may need to be authenticated by network service system 180A. Application 121 may cause user device 110A to prompt the user of user device 110A for credentials (e.g., a username and password combination). Application 121 interacts with network service system 180A over network 105, seeking to enable network service system 180A to authenticate the user. If authenticated, application 121 executing at user device 110A may continue to interact with network service system 180A.

Throughout this process (before, during, and/or after authentication), application 121 may collect information. For instance, once application 121 starts executing, application 121 begins collecting information about device attributes of user device 110A. Such attributes may include how much memory is installed at user device 110A, what type of processor(s) are installed, how fast those processors are capable of executing, what operating system or other software is installed at user device 110A, what other software is loaded into memory at user device 110A, how user device 110A is equipped to communicate over network 105, the IP address or MAC address associated with user device 110A, or other attributes.

Application 121 may also collect information about device activity before, during, and/or after authentication. For instance, once application 121 starts executing, application 121 also monitors information about operations taking place at user device 110A. Such operations may include information about processor utilization, processing operations performed, memory utilization (e.g., memory allocated, deallocated, and/or used), data transmitted, the type and nature of interactions by the user (e.g., with respect to a user interface), and/or other information about activity taking place at user device 110A.

User device 110A may use the collected information to create fingerprint data. For instance, still referring to FIG. 1, application 121 assembles the information collected into a series or sequence of fingerprint data 101A, where each instance of fingerprint data 101A corresponds to information about user device 110A during one specific period of time during a series of events occurring over the course of execution of application 121 at user device 110A. In some examples, each such period of time may be considered one ordinal, where an ordinal may be a short time slice associated with a specific interval of time during the execution of application 121. During each ordinal, application 121 creates a new instance of fingerprint data 101A, resulting in an ordered series of fingerprint data 101A, where each instance of fingerprint data 101A represents information about device attributes and/or device activity during each ordinal time period.

Computing system 140 may receive the fingerprint data. For instance, again with reference to FIG. 1, application 121 causes user device 110A to output the series of fingerprint data 101A over network 105, destined for computing system 140. Computing system 140 receives the series of fingerprint data 101A over network 105 (and private network 107). Computing system 140 determines that the series of fingerprint data 101A represents information about user device 110A and/or the actions of the user of user device 110A. Computing system 140 may use the series of fingerprint data 101A to create one or more fingerprint profiles 102 associated with user device 110A and/or the user operating user device 110A.

Computing system 140 may evaluate whether application 121 is operating as expected. For instance, computing system 140 evaluates the series fingerprint data 101A and/or fingerprint profiles 102. In some examples, computing system 140 uses known information about how application 121 operates or designed to operate during each ordinal to determine whether application 121 is operating as expected at user device 110A. Computing system 140 may determine a threat assessment based on whether application 121 is operating as expected. For example, if computing system 140 determines that application 121 is operating as expected (e.g., based on fingerprint data 101A), computing system 140 may conclude that the threat assessment for user device 110A or the user operating user device 110A is low. On the other hand, if computing system 140 determines that application 121 is not operating as expected (e.g., more memory than expected is being used, processing operations are significantly higher or lower than normal, operations are occurring in an unexpected order), computing system 140 may conclude that the threat assessment for user device 110A is high, indicating a potential threat.

Computing system 140 may evaluate whether application 121 is operating normally. For instance, computing system 140 evaluates the fingerprint data 101A by comparing the fingerprint data 101A to fingerprint data and/or profiles previously observed, collected, and stored for a user of user device 110A. Such previously stored fingerprint data may have been stored during prior instances in which application 121 was executing at user device 110A (or even at a different user device operated by the same user who purports to be currently operating user device 110A). Based on the comparison, computing system 140 may determine whether application 121 is operating normally at user device 110A. Computing system 140 may determine a threat assessment based on whether application 121 is operating normally. Such an assessment may indicate whether current device attributes and/or device activity associated with user device 110A (derived from fingerprint data 101A) are consistent with prior instances in which application 121 executed by the user operating user device 110A. If computing system 140 determines that the current fingerprint data 101A is consistent with prior data, computing system 140 may conclude the threat assessment is low. If computing system 140 determines that the current fingerprint data 101A is not consistent with prior data, computing system 140 may conclude that the threat assessment for user device 110A (or the user operating user device 110A) is high, indicating a potential threat.

Computing system 140 may generate threat assessment 103. For instance, as described above, computing system 140 may generate threat assessments both based on whether application 121 is operating as expected and based on whether application 121 is operating normally. Threat assessment 103 may represent a combination of those assessments. In general, threat assessment 103 may represent an appraisal of the threat posed by user device 110A (or the user operating user device 110A) to one or more protected resources, such as network service system 180A or any network service system 180. Although in some examples, computing system 140 generates threat assessment 103 based both on information about whether application 121 is operating as expected and whether application 121 is operating normally, in other examples, threat assessment 103 may be based on any combination of analyses that may be performed by computing system 140. For example, threat assessment 103 may be based, in some cases, only on whether application 121 is operating as expected, or in another case, only on whether application 121 is operating normally.

Computing system 140 may take action based on threat assessment 103. For example, if computing system 140 determines that threat assessment 103 indicates that the threat represented by user device 110A is low (e.g., the new fingerprint profile 102 is sufficiently consistent with previously stored fingerprint profiles 102), computing system 140 might not take any specific action, and may enable user device 110A to continue logging into and/or interacting with network service system 180A. If, on the other hand, computing system 140 determines that threat assessment 103 indicates that the threat represented by user device 110A is high (e.g., application 121 is not operating as expected), computing system 140 may take preventative or remediation action, possibly to prevent the user of user device 110A from successfully logging into network service system 180A. In a situation where computing system 140 takes action to prevent a log in attempt, computing system 140 may output control signals 109 over private network 107 to network service system 180A, instructing network service system 180A to deny a log in attempt by a user of user device 110A. In some cases, computing system 140 may instruct network service system 180A to require that the user of user device 110A overcome a higher-level authentication challenge, which may be escalated for each subsequent failed attempt to authenticate. Alternatively, or in addition, computing system 140 may interact with perimeter system 106 (or another system) to take precautionary, preventative, and/or remediation actions associated with what may be an unauthorized attempt by a user of user device 110A to access network service system 180A or another protected asset.

In some cases, computing system 140 may determine that threat assessment 103 is ambiguous, meaning, for example, that fingerprint data 101A does not clearly indicate whether user device 110A is operating as expected or normally. In such an example, computing system 140 may still take an action based on threat assessment 103, but the action may be less restrictive than denying access to network service system 180A, but more restrictive than simply enabling the user of user device 110A to gain full access to network service system 180A. In other words, computing system 140 might not necessarily prevent the user of user device 110A from logging into network service system 180A, but may nevertheless cause network service system 180A to require a higher level of authentication or provide a lower level of service (which might correspond to a lower set of privileges or rights available to the user of user device 110A). Accordingly, rather than being a binary indication of whether a threat exists or not, threat assessment 103 may provide a threat value along a continuum, where that continuum extends from little or no threat to a very high threat. Computing system 140 may have different ways to address each level of threat along the continuum.

Computing system 140 may continue to receive additional fingerprint data. For instance, again with reference to FIG. 1, in an example where threat assessment 103 is sufficiently low, computing system 140 enables the user of user device 110A to access network service system 180A. Accordingly, in such an example, a user operating user device 110A is authenticated to access services provided by network service system 180A, and user device 110A may continue to interact with network service system 180A over a period of time during an authenticated session. During session interactions between user device 110A and network service system 180A in an authenticated session, application 121 still continues to collect data about activity at user device 110A. Specifically, application 121 continues to assemble information about the activity at user device 110A into additional sets of fingerprint data 101A, each of which may correspond to an ordinal associated with execution of application 121. Application 121 continues outputting the additional sets of fingerprint data 101A over network 105 to computing system 140. Computing system 140 receives the fingerprint data 101A corresponding to information about user device 110A during an authenticated session between user device 110A and network service system 180A. Accordingly, fingerprinting operations associated with user device 110A extend beyond the perimeter of 107, in the sense that fingerprinting operations for user device 110A continues after the user of user device 110A is authenticated to access network service system 180A (or another network service system 180). Application 121 may continue to generate fingerprint data 101A during the entire session and may continue to communicate that fingerprint data 101A to computing system 140 for evaluation.

Computing system 140 may update threat assessment 103 in response to the additional fingerprint data collected after authentication. For instance, again with reference to FIG. 1, computing system 140 processes the fingerprint data 101A collected after the user of user device 110A has been authenticated, perhaps generating new or updated fingerprint profiles 102. Computing system 140 uses the new fingerprint data 101A and/or the new fingerprint profiles 102 to determine whether application 121 continues to operate normally and/or as expected. Alternatively, or in addition, computing system 140 determines whether application 121 is operating consistent with prior sessions by comparing a fingerprint profile 102 generated based on current fingerprint data 101 to previously stored fingerprint profiles 102. Based on one or more of these determinations, computing system 140 updates its threat assessment 103 about user device 110A and/or the user operating user device 110A.

Computing system 140 may enforce a threat assessment policy. For instance, based on the updated threat assessment 103, computing system 140 may take an action to enforce a threat mitigation policy designed to counter, mitigate, or prevent any threat that user device 110A may represent. For example, if the updated threat assessment 103 generated by computing system 140 is low, computing system 140 might not take any preventative or remediation action, and may simply enable user device 110A to continue interacting with network service system 180A. In other examples, however, if the updated threat assessment 103 is high (i.e., indicating that recent activity by user device 110A represents a threat), computing system 140 might take action by causing network service system 180A to restrict information, limit operations, or limit rights available to user device 110A or the user of user device 110A. In an extreme case, where the updated threat assessment 103 is sufficiently high, computing system 140 might cause network service system 180A to terminate the authenticated session between user device 110A and network service system 180A (e.g., by configuring perimeter system 106 to terminate the session or by sending control signals 109 to cause network service system 180A to terminate the session).

In at least some of the examples described above, user device 110A reports a stream of fingerprint data 101A to computing system 140, which enables computing system 140 to generate fingerprint profile 102 associated with user device 110A or a user of user device 110A. In a similar manner, each of user devices 110B through 110N may also install and execute application 121, generate a stream of fingerprint data 101, report such data to computing system 140, and thereby enable computing system 140 to generate corresponding fingerprint profiles 102 and threat assessments 103 for each of the user devices 110B through 110N. For instance, application 121 executing on user device 110B may collect fingerprint data 101B, output a stream of fingerprint data 101B to computing system 140, and enable computing system 140 to generate a threat assessment 103 for user device 110B. Computing system 140 may act on the threat assessment 103 for user device 110B in a manner similar to that described above in connection with the threat assessment 103 for user device 110A. And in general, an application 121 executing on user device 110N may collect fingerprint data 101N, output fingerprint data 101N to computing system 140, and computing system 140 may then generate a threat assessment 103 associated with user device 110N. Computing system 140 may also act on the threat assessment 103 for user device 110N as appropriate (e.g., by taking precautionary, preventative, and/or remediation actions for user device 110N).

In some cases, where a sufficient number of user devices are identified as having a high threat level, the threat assessment system may take precautionary, preventative, and/or remediation across a subset or across all user devices, including those that have not been assessed as having a high threat level. For example, it may be appropriate for the organization responsible for securing operations on private network 107 to conclude that a widespread threat to private network 107 exists when multiple user devices 110 are identified as having a high threat assessment 103. Accordingly, such an organization may have a policy in place to deal with a high number of user devices 110 being associated with a high threat assessment 103, and computing system 140 may enforce that policy.

Techniques described herein may provide certain technical advantages. For instance, where high-fidelity fingerprinting information is collected by user devices 110, it may be possible to identify instances where anomalous or unusual activity is taking place on a user device. Where application 121 is an application developed by the organization, likely everything about application 121 is known to the organization, including how application 121 is expected to operate. If computing system 140 also has knowledge about how application 121 is expected to operate, computing system 140 may be able to accurately identify unexpected or abnormal behavior and diagnose that behavior to determine potential causes.

For example, if user device 110 loads an image that is known to be 50 kilobytes in size, fingerprint data 101 should show that 50 kilobytes of memory was consumed by that image. However, if fingerprint data 101 indicates that more than 50 kilobytes of memory has been consumed by that image, something else may have leaked into memory, raising the prospect of unauthorized code has been loaded into memory on a given user device 110. In another example, fingerprint data 101 could show operations at user device 110 have occurred in an unexpected order or at a different cadence than expected. Computing system 140 may interpret fingerprint data 101 that reflects any of these situations as anomalous and potentially a red flag indicating a potential threat. In such examples, computing system 140 may determine that the threat assessment 103 for user device 110 (or the user of user device 110) has a higher threat level, and computing system 140 may take actions to limit operations performed by that user device 110.

In addition, and as described herein, high-definition fingerprint data is collected for a given user across a significant span of time (rather than a short-term snapshot), and possibly during an entire user experience when that user is interacting with a network service system. Using such fingerprint data, it may be possible to identify an unauthorized user that may have somehow gained access to a valid username and password combination, and has been able to authenticate and gain access to one or more of network service systems 180. In such a situation, that unauthorized user is essentially seeking to fake a profile in order to continue accessing the network service systems 180. If computing system 140 can determine that the unauthorized user or that user's device is acting abnormally or in an unexpected manner, computing system 140 may assign a heightened threat level to the user or device, and possibly take actions to limit or terminate that user's access to network service systems 180 or other systems.

In addition, techniques described herein can apply to fingerprinting operations for future devices, whether such devices are GPU or NPU-based, quantum computing systems, or any other type of system now known or hereafter developed. As the underlying computing system changes, the fingerprint data 101 generated by the underlying computing system would be unique, and would automatically change to fit the underlying system, further heightening the fidelity of fingerprint data 101. Also, where such future computing systems are capable of processing data more quickly, application 121 may be configured to scale fingerprinting data collection operations up or down as needed, such as based on the processing power of the computing system (e.g., collecting more data if appropriate, or collecting approximately equal data across diverse devices that have varying capabilities).

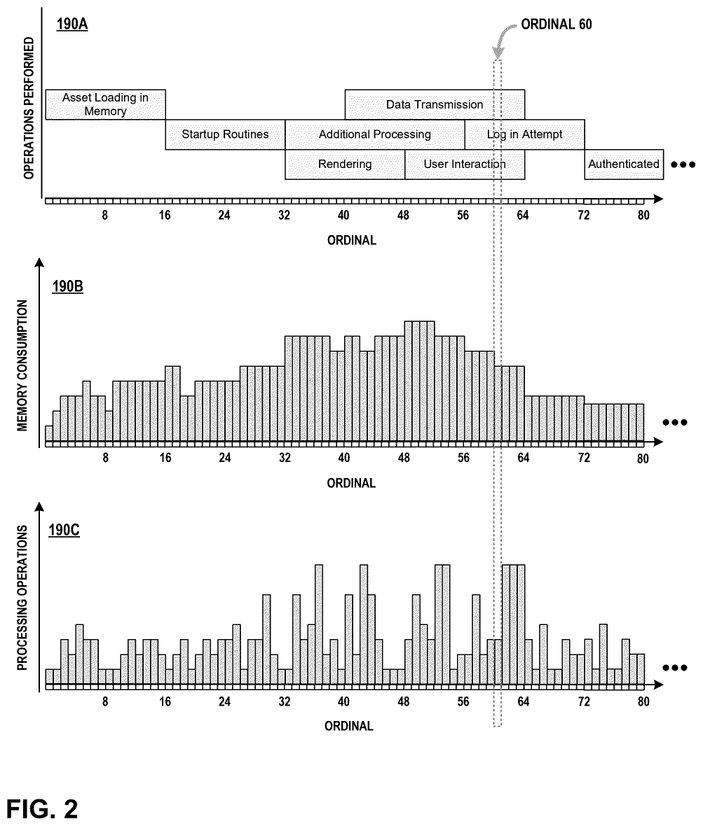

FIG. 2 is a conceptual diagram illustrating how information about a user device may be collected prior to and during an authenticated session, in accordance with one or more aspects of the present disclosure. FIG. 2 illustrates a timeline of operations (chart 190A) along with graphs (charts 190B and 190C) illustrating specific device data that may be used to create an instance of fingerprint data 101 for each of the ordinals depicted in each graph.

Chart 190A of FIG. 2 illustrates a timeline of startup, authentication, and post-authentication operations across eighty ordinals, which may be considered slices of time during the execution of application 121. The operations illustrated in FIG. 2 might correspond to application 121 of FIG. 1 starting to execute on one of user devices 110, such as user device 110A. Each operation takes place during a discrete timeframe illustrated in FIG. 2 in terms of ordinals, where an ordinal may be any slice of time appropriate for a given use case involving application 121 executing on a user device 110. For example, an ordinal may be a determination point, and may correspond to a time period lasting 100 nanoseconds, 50 milliseconds, 100 milliseconds, 500 milliseconds or any other appropriate length of time. The ordinal may define the machine level or instruction level detail over time measured at a precision defined by the organization or the developer of application 121. In some examples, the choice of an ordinal might be made pre-production if pre-production information gathering has high level of precision. In other examples, ordinal choices might be made on the fly and may be chosen for each session (resulting in potentially different choices for each session). In at least some examples, ordinal options may be selected on the fly, but certain aspects of the disclosed techniques may be more efficient if ordinal options are precompiled (e.g., into application 121).

Chart 190A of FIG. 2 is a very simplified illustration, and in an actual implementation, the number of ordinals between the start of application 121 executing through authentication is likely to be many more than that illustrated in FIG. 2. Yet chart 190A and the other charts illustrated in FIG. 2 provide a conceptual framework that show how fingerprinting across a number of ordinals may work in accordance with one or more aspects of the present disclosure.

In FIG. 2, and as illustrated in chart 190A, execution of application 121 starts at ordinal zero. The startup of application 121 causes a number of operations to be performed, some of which are performed in sequence, but others are performed in parallel. For instance, asset loading, startup routines, rendering might be performed in sequence, but other operations, such as data transmission and user interactions, might be performed in parallel or concurrently. As illustrated, asset loading in the conceptual example shown in chart 190A takes place during ordinals 0 to 15, after which startup routines execute until ordinal 32. Those operations are followed by additional processing, rendering, data transmission, user interactions, and a log in attempt, all occurring between ordinals 32 and 72. Operations occurring after the user is authenticated start at ordinal 72.

During each set of operations, varying levels of memory are consumed by application 121 (and other applications executing on user device 110), and varying levels of processor cycles are consumed by application 121 (along with other applications executing on user device 110). Chart 190B illustrates how memory consumption changes over ordinals 0 through 80. Chart 190C illustrates how the level of processing operations performed by user device 110 changes over ordinals 0 through 80.

Application 121 executing on user device 110 may generate fingerprint data 101 for a given ordinal by collecting information about the memory consumption and processing operations for that ordinal. For example, to generate fingerprint data 101 for ordinal 60, application 121 collects information about memory consumption for user device 110A at ordinal 60 (corresponding to the memory consumption value at ordinal 60 in chart 190B) and collects information about processing operations at user device 110A at ordinal 60 (corresponding to the processing operations value at ordinal 60 in chart 190C). In some cases, to generate fingerprint data 101 for ordinal 60, application 121 may also collect additional information about user device 110A or operations taking place at user device 110A. For example, such additional information may include information about data being transmitted (e.g., transmission speed, amount of data) information about user interactions (e.g., timeliness in responding to prompts or typing speed), information about the user's attempt to log in to a service (e.g., whether the user uses two-factor authentication or an “auto-fill” capability for typing a password). Application 121 assembles the collected information into fingerprint data 101, which can be shared with another system (e.g., computing system 140) to enable analysis, such as comparison of the fingerprint for a given ordinal to previous or expected fingerprints for that ordinal. Based on the analysis, another system (e.g., computing system 140) can generate a threat assessment 103 that provides some indication about whether the relevant user device 110 could present a threat to private network 107 or to assets associated with private network 107.

In some examples, application 121 may use a time fingerprinting technique to estimate processing attributes or utilization of the user device 110 on which application 121 executes. To apply such a technique, application 121 causes user device 110 to perform some amount of work that is expected to consume a significant amount of processing cycles. In one example, such work may involve the user device 110 generating tens of thousands of secure random numbers, but many other types of workloads may also be used for time-based fingerprinting. In some examples, the number of sets and the number of random numbers generated in a set could vary at different points during execution of application 121 (or while a web page is in full use). Application 121 observes the amount of time that it takes for user device 110 to perform the work, and records the amount of time taken. User device 110 may be able to perform the work very quickly, and in some cases, user device 110 may be able to perform the work so quickly that the elapsed time appears, from the perspective of application 121, to be zero (i.e., the amount of time that user device 110 takes to do the work is so small that it is less than the smallest time span that application 121 is capable of measuring). In other cases, however, due to random factors or other processing demands on user device 110, application 121 may observe the amount of time taken to perform the work is non-zero. Application 121 causes user device 110 to perform this process numerous times, and records the amount of elapsed time observed by application 121 for each process. Accordingly, application 121 may generate an array of elapsed time values which may have the form:

{0, 0, 0, 0.065, 0.024, 0, 0, 0.101, 0, 0, . . . }

The above array of values may be used to generate fingerprinting information for processing operations spanning a number of number of ordinals. For example, the mean, mode, or median of the array of values might be used as the processing attribute of a given instance of fingerprint data 101.

To obtain other data used for generating fingerprint data 101, application 121 may make operating system calls or take advantage of services provided by user device 110 or the operating system executing on user device 110. For example, to determine information about memory attributes, application 121 may make operating system calls to obtain information about available memory, heap, memory, memory used, memory allocated, and memory reserved in the allocation. Similar operating system calls can be used to about data transmission rates, user interactions, and device attributes (e.g., device name, IP address, MAC address). In some cases, user interactions and other information may already be being reported automatically to application 121 by the operating system as events (e.g., enabling application 121 to manage and update its own user interface).

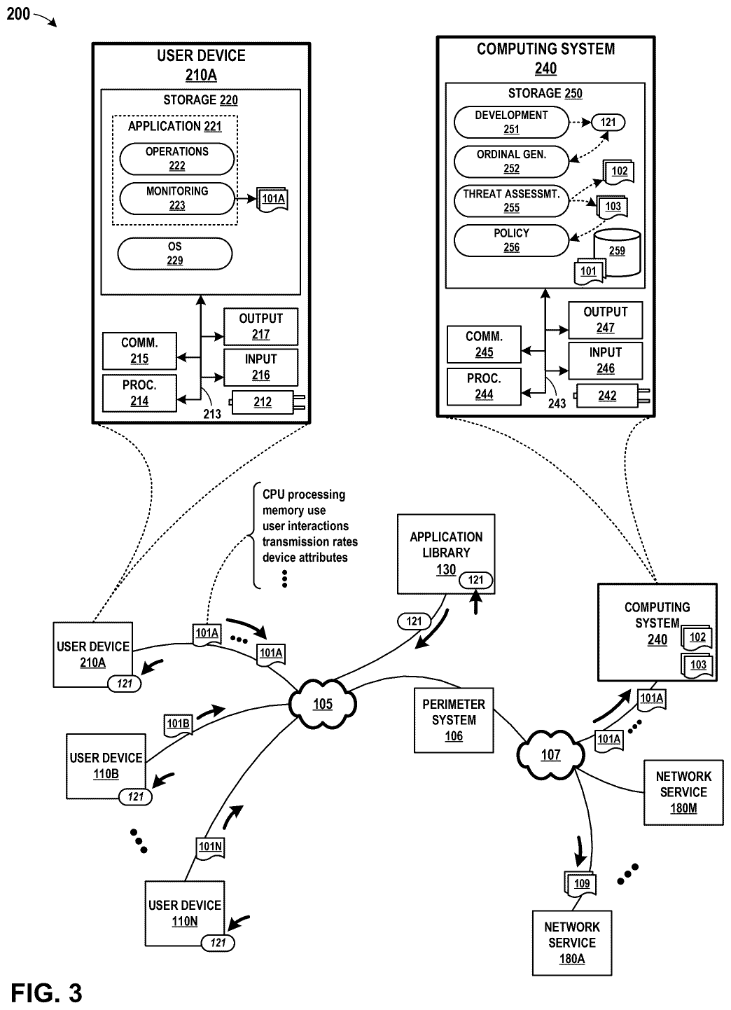

FIG. 3 is a block diagram illustrating an example system for performing fingerprinting and analysis, in accordance with one or more aspects of the present disclosure. System 200 of FIG. 3 includes many of the same elements of system 100 described in connection with FIG. 1. Elements illustrated in FIG. 3 may correspond to earlier-described elements sharing the same reference numeral. Also, computing system 240 of FIG. 3 may correspond to computing system 140 of FIG. 1, and user devices 210 in FIG. 3 may correspond to user devices 110 of FIG. 1.

Also illustrated in FIG. 3 are block diagram versions of computing system 240 and one of user devices 210 (i.e., user device 210A). The block diagram version of computing system 240 may be considered an example or alternative implementation of computing system 140 of FIG. 1, and the block diagram version of user device 210A may be considered an example or alternative implementation of any of user devices 210 in FIG. 3 or user devices 110 of FIG. 1. Accordingly, computing system 240 of FIG. 3 may operate in a manner similar to computing system 140 of FIG. 1, and user device 210A may operate in a manner similar to any of user devices 210 or user devices 110 illustrated in FIG. 1. For example, computing system 240 may receive fingerprint data 101A from user device 210A and generate fingerprint profiles 102 and threat assessments 103 for a user of user device 210A, in a manner similar to that described in connection with FIG. 1. Although computing system 240 of FIG. 3 may be considered an example implementation of computing system 140 of FIG. 1, and user device 210A may be considered an example of any of user devices 210 or user devices 110, other implementations are possible.

Computing system 240 is illustrated in FIG. 3 in block diagram form to facilitate a description of certain components, modules, and other aspects of a computing system that may implement a system for performing fingerprinting as described herein. Computing system 240 is also illustrated in FIG. 3 to facilitate a description of how such a computing system may operate in accordance with techniques described herein. For ease of illustration, computing system 240 is depicted in FIG. 3 as a single computing system. However, in other examples, computing system 240 may be implemented through multiple devices or computing systems distributed across a data center, multiple data centers, multiple cloud networks, or otherwise. For example, separate computing systems may implement functionality described herein as being performed by each of various modules of computing system 240, including development module 251, ordinal generator module 252, threat assessment module 255, and policy module 256. Alternatively, or in addition, modules illustrated in FIG. 3 as included within computing system 240 may be implemented through distributed virtualized compute instances (e.g., virtual machines, containers) of a data center, cloud computing system, server farm, and/or server cluster.

In FIG. 3, computing system 240 is shown with underlying physical hardware that includes power source 242, one or more processors 244, one or more communication units 245, one or more input devices 246, one or more output devices 247, and one or more storage devices 250. One or more of the devices, modules, storage areas, or other components of computing system 240 may be interconnected to enable inter-component communications (physically, communicatively, and/or operatively). In some examples, such connectivity may be provided by through communication channels, which may include a system bus (e.g., communication channel 243), a network connection, an inter-process communication data structure, or any other method for communicating data.

In the example of FIG. 3, power source 242 of computing system 240 may provide power to one or more components of computing system 240. Power source 242 may receive power from an alternating current (AC) power supply in a building, data center, or other location. In some examples, power source 242 may be or include a battery or a device that supplies direct current (DC). Power source 242 may have intelligent power management or consumption capabilities, and such features may be controlled, accessed, or adjusted by processors 244 to intelligently consume, allocate, supply, or otherwise manage power.

One or more processors 244 of computing system 240 may implement functionality and/or execute instructions associated with computing system 240 or associated with one or more modules illustrated herein and/or described herein. One or more processors 244 may be, may be part of, and/or may include processing circuitry that performs operations in accordance with one or more aspects of the present disclosure. Such processors may be mobile processors, desktop processors, server processors, compute nodes, virtualized processors, neural processing units or NPUs, graphics processing units or GPUs, quantum computing processors, and/or other types of processors or processing circuitry. Processors 244 may execute the instructions of one or more processes loaded into memory of computing system 240 and may implement functionality of such processes.

One or more communication units 245 of computing system 240 may communicate with devices external to computing system 240 by transmitting and/or receiving data, and may operate, in some respects, as both an input device and an output device. Communication units 245 may enable computing system 240 to communicate with other computing devices and systems using any appropriate communication protocol (e.g., TCP/IP) and over any appropriate medium. In some or all cases, one or more communication units 245 may communicate with other devices or computing systems over a network. For example, communication units 245 may enable computing system 240 to communicate with any other device over networks 105 and/or 107 in FIG. 3, such as any of user devices 210, network service systems 180, perimeter system 106, and/or library system 130.

One or more input devices 246 may represent any input devices of computing system 240, and one or more output devices 247 may represent any output devices of computing system 240. Input devices 246 and/or output devices 247 may generate, receive, and/or process output from any type of device capable of outputting information to a human or machine. For example, one or more input devices 246 may generate, receive, and/or process input in the form of electrical, physical, audio, image, and/or visual input (e.g., peripheral device, keyboard, microphone, camera). Correspondingly, one or more output devices 247 may generate, receive, and/or process output in the form of electrical and/or physical output (e.g., peripheral device, actuator).

One or more storage devices 250 within computing system 240 may store information for processing during operation of computing system 240. Storage devices 250 may store program instructions and/or data associated with one or more of the modules described in accordance with one or more aspects of this disclosure. One or more processors 244 and one or more storage devices 250 may provide an operating environment or platform for such modules, which may be implemented as software, but may in some examples include any combination of hardware, firmware, and software. One or more processors 244 may execute instructions and one or more storage devices 250 may store instructions and/or data of one or more modules. The combination of processors 244 and storage devices 250 may retrieve, store, and/or execute the instructions and/or data of one or more applications, modules, or software. Processors 244 and/or storage devices 250 may also be operably coupled to one or more other software and/or hardware components, including, but not limited to, one or more of the components of computing system 240 and/or one or more devices or systems illustrated or described as being connected to computing system 240.

Storage devices 250 may include development module 251, ordinal generator module 252, threat assessment module 255, policy module 256, and data store 259. Development module 251 may perform functions relating to development of an application, such as application 121. Ordinal generator module 252 may perform functions relating to processing or augmenting an application (e.g., application 121) to enable the application to collect or enable the collection of fingerprint data when executing at one of user devices 210. Threat assessment module 255 may perform functions relating to determining the extent to which fingerprint data 101 indicates that a given user device 210 or a user of such a user device 210 represents a threat to any asset that can be accessed over private network 107. Policy module 256 may perform functions relating to enforcing a policy driven by various threat assessment levels, as determined by threat assessment module 255.

Data store 259 of computing system 240 may represent any suitable data structure or storage medium for storing information relating to storing fingerprint data 101, fingerprint profiles 102, threat assessments 103, and/or related data. The information stored in data store 259 may be searchable and/or categorized such that one or more modules within computing system 240 may provide an input requesting information from data store 259, and in response to the input, receive information stored within data store 259. Data store 259 may be primarily maintained by threat assessment module 255.

User device 210A is also illustrated in FIG. 3 as a block diagram with specific components and data modules. For ease of illustration, one user device 210 is depicted in block diagram form in FIG. 3. However, many other user devices 210 could be illustrated (and implemented) in a manner similar to user device 210A, although not all of user devices 210 need be implemented in the same way. User device 210A is illustrated in FIG. 3 to facilitate a description of how such a device or system may operate in accordance with techniques described herein. User device 210A is also illustrated in FIG. 3 to facilitate a description of certain components, modules, and other aspects of an example user device 110 or user device 210.

The following description of components and data modules included within user device 210A may also apply to any of user devices 210 in FIG. 3, user devices 110 in FIG. 1, or in some cases, other computing devices illustrated herein. As illustrated in FIG. 3, user device 210A includes power source 212, one or more processors 214, one or more communication units 215, one or more input devices 216, one or more output devices 217, and one or more storage devices 220. These components may be implemented in the manner described with respect to similar components (e.g., those of computing system 240) also described herein.

For example, power source 212 may provide power to one or more components of user device 210A. One or more processors 214 may implement functionality and/or execute instructions associated with user device 210A or associated with one or more modules of user device 210A. One or more communication units 215 of user device 210A may communicate with devices external to user device 210A by transmitting and/or receiving data over a network or otherwise. One or more input devices 216 and output devices 217 may generate, receive, and/or process input and output. One or more storage devices 220 may store program instructions and/or data associated with one or more of the modules stored within storage devices 220 in accordance with one or more aspects of this disclosure. One or more of the devices, modules, storage areas, or other components of user device 210A may be interconnected (e.g., by communication channel 213A).

Input devices 216 and output devices 217 may each function as an input and/or output device or set of input/output devices, and may be implemented using various devices, components, and/or technologies. For example, input devices 216 and output devices 217 may include one or more user interface devices that include presence-sensitive input panel technologies, microphone technologies, voice activation and/or recognition technologies, cameras, sensor technologies (e.g., infrared, image, location, motion, accelerometer, gyrometer, magnetometer), or other input device technology for use in receiving user input. Such user interface devices may include display devices, speaker technologies, haptic feedback technologies, tactile feedback technologies, light emitting technologies, or other output device technologies for use in outputting information to a user.

Application 221 may correspond to an application developed and/or distributed by the organization described in connection with FIG. 1, and may include operations module 222 and monitoring module 223. Operations module 222 may perform functions relating to the core functions for which application 221 was developed (e.g., a banking application, enabling money transfers, access to banking services, and access to banking information). Monitoring module 223 may perform functions relating to collecting data associated with operations performed by user device 210A or a user of user device 210A and assembling fingerprint data 101A. In some examples, operations module 222 and monitoring module 223 may be integrated into the same application 221. In other examples, operations module 222 and monitoring module 223 may be separate, and monitoring module 223 may interact with operations module 222 (or application 221) and/or user device 210A to collect information sufficient to generate fingerprint data 101A. Accordingly, in some examples, monitoring module 223 might be part of another application or mobile device app that executes on user device 210A. In other examples, monitoring module 223 be a stand-alone module that operates independently of operations module 222 in at least some respects.

Operating system 229 may represent the operating system controlling administrative and other functions of user device 210A. Operating system 229 may be a mobile device operating system or desktop operating system. In some examples, operating system 229 may be considered a browser for browser-based implementations of application 221.

Computing system 240 may be used to develop an application. For instance, in an example that can be described with reference to FIG. 3, input device 246 detects a series of input and outputs information about the input to development module 251. Development module 251 determines that the input corresponds to development activity for an application to be executed at one or more of user devices 210. After sufficient input associated with development activity is received, development module 251 generates application 121, representing an application intended to execute at one or more of user devices 210.

Computing system 240 may prepare application 121 for performing fingerprinting operations. For instance, in the example being described with reference to FIG. 3, development module 251 outputs information about application 121 to ordinal generator module 252. Ordinal generator module 252 analyzes and/or processes application 121 and creates code that can collect fingerprinting information (e.g., fingerprint data 101) for each of a number of operations performed by 121 (e.g., for each ordinal or determination point associated with execution of application 121). In some examples, ordinal generator module 252 integrates the code for collecting fingerprinting information (or fingerprint data 101) into application 121, thereby creating a modified application 121 that not only performs the core functions for which application 121 was intended (e.g., banking operations, communications, trading operations, funds transfers), but also generates fingerprint data 101 while application 121 executes on the user device 210. In other examples, ordinal generator module 252 may generate a separate module or separate application that interfaces with or interacts with application 121 to collect information about operations that application 121 performs on the underlying user device 210 on which application 121 executes. In still other examples, ordinal generator module 252 implements other or additional procedures that enable collection of fingerprinting information or fingerprint data 101 associated with any given user device 210.

Computing system 240 may publish application 121 at library system 130. For instance, again referring to FIG. 3, and once application 121 has been processed to enable collection of fingerprint data 101, ordinal generator module 252 causes communication unit 245 of computing system 240 to output a signal over private network 107. Library system 130 detects a signal over 107 and determines that the signal includes information about application 121. Library system 130 uses the information to publish application 121, making the published application 121 available for download and installation by one or more of user devices 210.

Any of user devices 210, such as user device 210A, may install application 121. For instance, still with reference to FIG. 3, input device 216 of user device 210A detects input and outputs information about the input to operating system 229. Operating system 229 determines that the input corresponds to a request to install an application at user device 210A. Operating system 229 causes communication unit 215 to output a signal over network 105. Library system 130 receives a signal over network 105 and determines that it corresponds to a request, by user device 210A, to install application 121. Library system 130 outputs a series of signals over network 105. User device 210A detects the series of signals over network 105, and operating system 229 of user device 210A determines that the series of signals includes information sufficient to install application 121. Operating system 229 installs application 121 at user device 210A as application 221. As illustrated in computing system user device 210A in FIG. 3, and as further described herein, application 221 may include operations module 222 and monitoring module 223.

User device 210A may start executing application 221. For instance, again referring to FIG. 3, input device 216 detects input that operating system 229 determines corresponds to a request to start executing application 221. Operations module 222 of application 221 starts executing, performing various operations associated with the productive purpose for which application 221 was designed (e.g., operations associated with a mobile banking app). When application 221 starts executing, such productive operations may include operations illustrated in chart 190A of FIG. 2, and may include loading data into memory, starting startup routines, rendering user interface object to present a user interface, transmitting data over network 105, receiving interactions from a user of user device 210A, and other functions associated with the purpose of application 221.

User device 210A may monitor operations associated with application 221. For instance, while operations module 222 of application 221 is performing the productive operations described above, monitoring module 223 of application 221 collects data. To do so, monitoring module 223 of application 221 may monitor both hardware and software associated with user device 210A, and may interact with operating system 229 to take advantage of any services provided by operating system 229 that can be leveraged to help collect information about user device 210A or operations taking place at user device 210A. In some examples, monitoring module 223 may monitor processing performed at user device 210A, memory allocated and/or used, data transmitted, user input or interactions, and/or other activity. Monitoring module 223 may implement a time-based fingerprinting technique (as described in connection with FIG. 2) for collecting information about operations associated with processor 214. Monitoring module 223 may also implement a time-based fingerprinting technique when collecting information about other operations of user device 210A. Monitoring module 223 assembles the collected information into a series of fingerprint data 101A, where each instance of fingerprint data 101A corresponds to information about user device 210A for an ordinal or other time period during which application 221 executes.

Computing system 240 may receive fingerprinting information from user device 210A. For instance, monitoring module 223 of application 221 causes communication unit 215 to output a series of signals over network 105. Communication unit 245 of computing system 240 detects a series of signals over network 105 and/or private network 107. Communication unit 245 outputs information about the series of signals to threat assessment module 255 of computing system 240. Threat assessment module 255 of computing system 240 determines that the series of signals corresponds to a sequence of fingerprint data 101A from user device 210A. Threat assessment module 255 may use the series of fingerprint data 101A to create one or more fingerprint profiles 102 associated with user device 210A and/or a user operating user device 210A.

Computing system 240 may perform a threat assessment using fingerprint data 101A. For instance, threat assessment module 255 evaluates the sequence of fingerprint data 101A and/or the corresponding fingerprint profiles 102. In some examples, threat assessment module 255 determines, based on fingerprint data 101A, whether user device 210A is operating normally and as expected. In some examples, threat assessment module 255 may access previously stored fingerprint profiles 102 within data store 259 and compare those profiles to a new fingerprint profile 102 generated based on recent fingerprint data 101A. Based on this analysis, threat assessment module 255 determines threat assessment 103. In at least some examples, if threat assessment module 255 concludes that user device 210A is not operating normally or as expected, threat assessment module 255 may assign a high threat assessment level to user device 210A and/or the user operating user device 210A. Correspondingly, if threat assessment module 255 concludes that user device 210A is operating normally and as expected, threat assessment module 255 may assign a low threat assessment level to user device 210A and/or the user operating user device 210A.

Computing system 240 may enforce threat level-based policy. For instance, again with reference to FIG. 3, threat assessment module 255 outputs threat assessment 103 (or information about threat assessment 103) to policy module 256. Policy module 256 determines whether a preventative, precautionary, remediation, or other action should be taken based on threat assessment 103. In some examples, policy module 256 determines that no action is needed to implement or enforce any threat policy in place for private network 107 or network service systems 180 (e.g., threat assessment 103 is sufficiently low). In other examples, policy module 256 determines that one or more preventative, precautionary, remediation, or other actions should be taken to enforce a threat policy in place for private network 107 and/or network service systems 180. To take an action, policy module 256 causes communication unit 245 to output control signals 109 to one or more other systems, including perimeter systems 106, network service systems 180, or any other system capable of being controlled by computing system 240. In at least some examples, policy module 256 of computing system 240 causes such systems to take precautionary, preventative, and/or remediation actions pursuant to a threat policy.

In the example described above, user device 210A installs an application 121 downloaded from library system 130 over network 105. Such an application 121 may be a desktop application that executes within user space on a desktop computing device (e.g., a Windows, Mac OS, or Linux system). Such an application 121 could also be an “app” that executes on a mobile device (e.g., an iOS or Android-based device). In both of these cases, the application 121 may have a relatively high level of access, privileges, and administrative rights enabling visibility into resources used by application 121 and/or information about the user device 210 on which application 121 executes. Such visibility can be useful when collecting information about user device 210 and assembling fingerprint data 101.

In another example, however, application 221 may be embodied in a web page that executes within a browser executing on a given user device 210. For instance, when application 221 is implemented as a web page, such an application 221 may still comprise operations module 222 and monitoring module 223, where operations module 222 may be implemented through HTML and code (e.g., JavaScript) embedded within the HTML, and monitoring module 223 may also be implemented through JavaScript embedded within the web page. When implemented as a web page, operations module 222 of application 221 begins executing upon loading of the web page, and monitoring module 223 may monitor operations associated with the execution. Specifically, monitoring module 223 may monitor, through JavaScript embedded within (or referenced within) the web page, assets being loaded into memory, startup routines being initiated and performed, user interface objects being rendered, data being transferred, login attempts being made, web page content, load order, and other operations. Monitoring module 223 may observe that certain content load processes are longer or more memory intensive. In some examples, collection of fingerprint data might be scaled so that the fingerprint generation collide, possibly forcing user device 210A to multi-task and distribute processing for both.

Where application 221 is embodied in a web page, application 221 may be subject to more stringent limitations on its access to resources of user device 210. For example, code within a web page that is executed within a browser is often given limited administrative or user privileges to prevent the code from accessing protected or secure resources of user device 210 or obtaining private information about the user of user device 210. Yet even code executed within a browser may still have enough privileges to perform techniques in accordance with aspects of the present disclosure. In other words, while JavaScript embedded within a web page might not have a high level of access to the underlying hardware of the user device 210 on which the JavaScript executes, browser-executed JavaScript still typically has enough access privileges to generate sufficient fingerprinting information.

For example, time-based fingerprinting techniques can still be used to determine information about processing operations performed by processor 214 by taking advantage of certain operating system calls available to code executing within a browser. Specifically, modern browsers typically enable code executing within the browser to cause the underlying operating system to generate a list of secure random numbers, which can be used to perform time-based fingerprinting as described in connection with FIG. 3. In addition, other operating system calls are also typically available to code executing within a browser that provides a picture of memory associated with the underlying user device 210 on which the browser is executing. For example, there is typically a JavaScript function that can provide information about available memory, and the amount of heap or other memory in use at a given time.

Accordingly, monitoring module 223, as implemented by JavaScript within a web page, can interact with operating system 229 to make operating system calls to cause the underlying processor 214 for a given user device 210 to perform operations when performing time-based fingerprinting for processor operations. In addition, monitoring module 223, as implemented by JavaScript within a web page, may be able to learn information about memory consumed, used, or allocated on the underlying user device 210. Also, information about user interactions with the web page presented by application 221 within the browser is typically accessible to monitoring module 223 in the web page implementation (e.g., reported to application 221 as events). Accordingly, when application 221 is implemented as a web page, monitoring module 223 can still generate fingerprint data 101 and communicate that fingerprint data 101 to computing system 240, thereby enabling computing system 240 to generate fingerprint profiles 102, create threat assessments 103, and enforce policy by interacting or controlling other systems.

In some cases, the level of granularity or time-based precision of fingerprint data 101 may depend on how monitoring module 223 and/or application 221 is implemented. For example, when implemented in a web page, monitoring module 223 and/or application 221 might collect fingerprint data 101 at a level of precision measured in milliseconds. On the other hand, if implemented as a desktop or other near-native application, monitoring module 223 and/or application 221 might be able to collect fingerprint data 101 at a higher level of precision, such as a level measured in nanoseconds.

Notably, regardless of the environment in which monitoring module 223 operates (e.g., desktop application, mobile device application, web page, or otherwise) tampering with monitoring module 223 in any way (e.g., to deceive or perform fake operations) will still likely manifest as abnormal or unexpected behavior. In most cases, such tampering will change time frames for operations performed by operations module 222, and the deviations will break the ordinal and/or alter corresponding fingerprint data 101.

Modules illustrated in FIG. 3 (e.g., application 221, operations module 222, monitoring module 223, operating system 229, development module 251, ordinal generator module 252, threat assessment module 255, and policy module 256) and/or illustrated or described elsewhere in this disclosure may perform operations described using software, hardware, firmware, or a mixture of hardware, software, and firmware residing in and/or executing at one or more computing devices. For example, a computing device may execute one or more of such modules with multiple processors or multiple devices. A computing device may execute one or more of such modules as a virtual machine executing on underlying hardware. One or more of such modules may execute as one or more services of an operating system or computing platform. One or more of such modules may execute as one or more executable programs at an application layer of a computing platform. In other examples, functionality provided by a module could be implemented by a dedicated hardware device.

Although certain modules, data stores, components, programs, executables, data items, functional units, and/or other items included within one or more storage devices may be illustrated separately, one or more of such items could be combined and operate as a single module, component, program, executable, data item, or functional unit. For example, one or more modules or data stores may be combined or partially combined so that they operate or provide functionality as a single module. Further, one or more modules may interact with and/or operate in conjunction with one another so that, for example, one module acts as a service or an extension of another module. Also, each module, data store, component, program, executable, data item, functional unit, or other item illustrated within a storage device may include multiple components, sub-components, modules, sub-modules, data stores, and/or other components or modules or data stores not illustrated.

Further, each module, data store, component, program, executable, data item, functional unit, or other item illustrated within a storage device may be implemented in various ways. For example, each module, data store, component, program, executable, data item, functional unit, or other item illustrated within a storage device may be implemented as a downloadable or pre-installed application or “app. ” In other examples, each module, data store, component, program, executable, data item, functional unit, or other item illustrated within a storage device may be implemented as part of an operating system executed on a computing device.

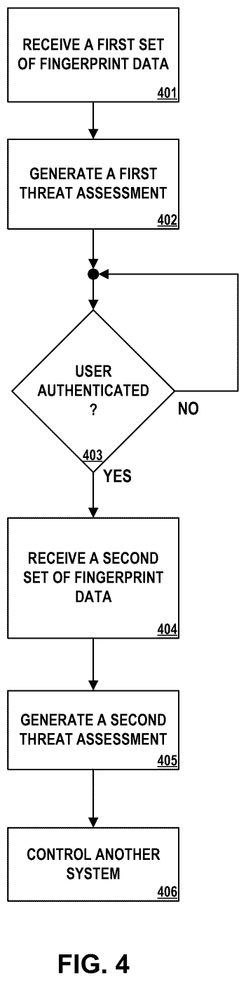

FIG. 4 is a flow diagram illustrating operations performed by an example fingerprinting system, in accordance with one or more aspects of the present disclosure. FIG. 4 is described herein within the context of computing system 240 of FIG. 3, where computing system 240 of FIG. 3 may be considered a fingerprinting system or a system for analyzing fingerprint data. In other examples, operations described in FIG. 4 may be performed by one or more other components, modules, systems, or devices. Further, in other examples, operations described in connection with FIG. 4 may be merged, performed in a difference sequence, omitted, or may encompass additional operations not specifically illustrated or described.

In the process illustrated in FIG. 4, and in accordance with one or more aspects of the present disclosure, computing system 240 may receive a first set of fingerprint data (401). For example, with reference to FIG. 3, user device 210A detects input directing it to retrieve a web page published at network service system 180A. User device 210A retrieves a web page from network service system 180A over network 105. User device 210A begins executing application 221, which is incorporated into or is referenced by the web page. Application 221 includes operations module 222 and monitoring module 223. Operations module 222 of application 221 causes assets to be loaded in memory, startup routines to be executed, web page objects to be rendered in a browser, and other operations to be performed. Operations module 222 may also initiate an authentication process to authenticate a user of user device 210A. During such operations, monitoring module 223 of application 221 collects information about operations being performed by user device 210A over the course of multiple ordinals. Monitoring module 223 collects information about processing operations, processing utilization, memory available, memory allocated, memory used, user interactions with the web page, and/or other information about user device 210A. Monitoring module 223 assembles the information into a fingerprint data 101A, where each instance of fingerprint data 101A is associated with operations performed by user device 210A prior to a user of user device 210A being authenticated by network service system 180A. Monitoring module 223 causes user device 210A to output the fingerprint data 101A over network 105 and private network 107 to computing system 240. Computing system 240 receives a series of fingerprint data 101A as the first set of fingerprint data.

Computing system 240 may generate a first threat assessment (402). For example, computing system 240 analyzes the first set of fingerprint data 101A and evaluates whether it indicates that user device 210A is operating normally and as expected. Based on the analysis, computing system 240 determines a threat assessment 103.

Computing system 240 may determine that the user has been authenticated (403). For example, monitoring module 223 of user device 210A continues to collect additional instances of fingerprint data 101A. User device 210A outputs the additional instances of fingerprint data 101A over network 105. Computing system 240 receives the additional instances of fingerprint data 101A and determines whether a user of user device 210A has been successfully authenticated by network service system 180A (YES path from 403) or not (NO path from 403).

Computing system 240 may receive a second set of fingerprint data (404). For example, monitoring module 223 continues to collect additional fingerprint data 101A at user device 210A. In the example being described, these additional instances of fingerprint data 101A are associated with operations performed by user device 210A after a user has been authenticated by network service system 180A. User device 210A outputs the fingerprint data 101A over network 105 to computing system 240. Computing system 240 receives the fingerprint data as the second set of fingerprint data 101A.

Computing system 240 may generate a second threat assessment (405). For example, computing system 240 evaluates the second set of fingerprint data 101A and evaluates whether it indicates that user device 210A is operating normally and/or as expected. In some examples, computing system 240 also performs such an evaluation by also considering the first set of fingerprint data 101A. Based on the evaluation, computing system 240 generates an updated or second threat assessment.

Computing system 240 may control another system (406). For example, computing system 240 may take an action to implement a security policy associated with an organization. Such an action may include computing system 240 sending control signals to control perimeter system 106 or one or more one or more of network service systems 180. In one example, if the updated threat assessment indicates a high risk, policy module 256 of computing system 240 may send control signals to perimeter system 106, instructing perimeter system 106 to perform a specific operations, such as modifying configurations to limit access by user device 210A or another device to one or more of network service systems 180 on private network 107. In such an example, perimeter system 106 receives the control signals and determines that the signals include instructions for performing modifications to the configurations. Perimeter system 106 carries out the modifications as directed by computing system 240. Accordingly, computing system 240 controls the operation of perimeter system 106 in this example.

In another example, computing system 240 may output a series of control signals 109 to cause network service system 180A to modify its operation (e.g., by limiting information, rights, or access privileges for user device 210A). Network service system 180A receives the control signals 109 and determines that the signals include instructions for adjusting available information, rights, and/or access privileges for user device 210A. Network service system 180A adjusts configurations as appropriate to carry out the instructions. Accordingly, computing system 240 may also control the operation of one or more of network service systems 180, causing the operation of such network service systems 180 to change based on control signals 109.

For processes, apparatuses, and other examples or illustrations described herein, including in any flowcharts or flow diagrams, certain operations, acts, steps, or events included in any of the techniques described herein can be performed in a different sequence, may be added, merged, or left out altogether (e.g., not all described acts or events are necessary for the practice of the techniques). Moreover, in certain examples, operations, acts, steps, or events may be performed concurrently, e.g., through multi-threaded processing, interrupt processing, or multiple processors, rather than sequentially. Further certain operations, acts, steps, or events may be performed automatically even if not specifically identified as being performed automatically. Also, certain operations, acts, steps, or events described as being performed automatically may be alternatively not performed automatically, but rather, such operations, acts, steps, or events may be, in some examples, performed in response to input or another event.

The disclosures of all publications, patents, and patent applications referred to herein are hereby incorporated by reference. To the extent that any material that is incorporated by reference conflicts with the present disclosure, the present disclosure shall control.

For ease of illustration, a limited number of devices (e.g., user devices 110, computing system 140, user devices 210, computing system 240, network service systems 180, as well as others) are shown within the illustrations referenced herein. However, techniques in accordance with one or more aspects of the present disclosure may be performed with many more of such systems, components, devices, modules, and/or other items, and collective references to such systems, components, devices, modules, and/or other items may represent any number of such systems, components, devices, modules, and/or other items.

The illustrations included herein depict at least one example implementation of an aspect of this disclosure. The scope of this disclosure is not, however, limited to such implementations. Accordingly, other example or alternative implementations of systems, methods or techniques described herein, beyond those illustrated, may be appropriate in other instances. Such implementations may include a subset of the devices and/or components included in the illustrations and/or may include additional devices and/or components not specifically illustrated.

The detailed description set forth above is intended as a description of various configurations and is not intended to represent the only configurations in which the concepts described herein may be practiced. The detailed description includes specific details for the purpose of providing a sufficient understanding of the various concepts. However, these concepts may be practiced without these specific details. In some instances, well-known structures and components are shown in block diagram form in the referenced illustrations in order to avoid obscuring such concepts.

Accordingly, although one or more implementations of various systems, devices, and/or components may be described with reference to specific illustrations, such systems, devices, and/or components may be implemented in a number of different ways. For instance, one or more devices illustrated herein as separate devices may alternatively be implemented as a single device; one or more components illustrated as separate components may alternatively be implemented as a single component. Also, in some examples, one or more devices illustrated herein as a single device may alternatively be implemented as multiple devices; one or more components illustrated as a single component may alternatively be implemented as multiple components. Each of such multiple devices and/or components may be directly coupled via wired or wireless communication and/or remotely coupled via one or more networks. Also, one or more devices or components that may be illustrated herein may alternatively be implemented as part of another device or component not shown in such illustrations. In this and other ways, some of the functions described herein may be performed via distributed processing by two or more devices or components.

Further, certain operations, techniques, features, and/or functions may be described herein as being performed by specific components, devices, and/or modules. In other examples, such operations, techniques, features, and/or functions may be performed by different components, devices, or modules. Accordingly, some operations, techniques, features, and/or functions that may be described herein as being attributed to one or more components, devices, or modules may, in other examples, be attributed to other components, devices, and/or modules, even if not specifically described herein in such a manner. References herein to “real time” or equivalent phrases are intended to encompass near-real time or seemingly near-real time, such as from the perspective of a reasonable human observer.

Although specific advantages have been identified in connection with descriptions of some examples, various other examples may include some, none, or all of the enumerated advantages. Other advantages, technical or otherwise, may become apparent to one of ordinary skill in the art from the present disclosure. Further, although specific examples have been disclosed herein, aspects of this disclosure may be implemented using any number of techniques, whether currently known or not, and accordingly, the present disclosure is not limited to the examples specifically described and/or illustrated in this disclosure.

In one or more examples, the functions described may be implemented in hardware, software, firmware, or any combination thereof. If implemented in software, the functions may be stored, as one or more instructions or code, on and/or transmitted over a computer-readable medium and executed by a hardware-based processing unit. Computer-readable media may include computer-readable storage media, which corresponds to a tangible medium such as data storage media, or communication media including any medium that facilitates transfer of a computer program from one place to another (e.g., pursuant to a communication protocol). In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can include RAM, ROM, EEPROM, or optical disk storage, magnetic disk storage, or other magnetic storage devices, flash memory, or any other medium that can be used to store desired program code in the form of instructions or data structures and that can be accessed by a computer. Also, any connection may properly be termed a computer-readable medium. For example, if instructions are transmitted from a website, server, or other remote source using a wired (e.g., coaxial cable, fiber optic cable, twisted pair) or wireless (e.g., infrared, radio, and microwave) connection, then the wired or wireless connection is included in the definition of medium. It should be understood, however, that computer-readable storage media and data storage media do not include connections, carrier waves, signals, or other transient media, but are instead directed to non-transient, tangible storage media.

Instructions may be executed by one or more processors, such as one or more digital signal processors (DSPs), general purpose microprocessors, graphics processing units (GPUs), application specific integrated circuits (ASICs), field programmable logic arrays (FPGAs), quantum processors, or other equivalent integrated or discrete logic circuitry. Accordingly, the terms “processor” or “processing circuitry” as used herein may each refer to any of the foregoing structure or any other structure suitable for implementation of the techniques described. In addition, in some examples, the functionality described may be provided within dedicated hardware and/or software modules. Also, the techniques could be fully implemented in one or more circuits or logic elements.

The techniques of this disclosure may be implemented in a wide variety of devices or apparatuses, including, to the extent appropriate, a wireless handset, a mobile or non-mobile computing device, a wearable or non-wearable computing device, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperating hardware units, including one or more processors as described above, in conjunction with suitable software and/or firmware.

What is claimed is:

1. A method comprising:
receiving, by a computing system and over a network from a user device, a first set of fingerprint data, wherein the first set of fingerprint data reflects operations performed by the user device before a network service system authenticates a user of the user device;
generating, by the computing system and based on the first set of fingerprint data, a first threat assessment associated with the user;
receiving, by the computing system, and over the network from the user device, a second set of fingerprint data, wherein the second set of fingerprint data reflects operations performed by the user device after the network service system authenticates the user of the user device;
generating, by the computing system and based on the first set of fingerprint data and the second set of fingerprint data, a second threat assessment; and
sending, by the computing system and based on the second threat assessment, control signals to a system on the network to cause the system to implement a threat mitigation policy.

2. The method of claim 1,
wherein the first set of fingerprint data includes information about startup processes performed by an application executing on the user device; and
wherein the second set of fingerprint data includes information about functions performed during an authenticated session by the application executing on the user device.

3. The method of claim 1, further comprising:
determining, by the computing system and prior to generating the second threat assessment, that the user has been authenticated by the network service system.

4. The method of claim 1,
wherein the first set of fingerprint data includes information about at least one of:
processor utilization, memory consumption, user interactions, or data transmitted associated with the user device.

5. The method of claim 1,
wherein the second set of fingerprint data includes information about at least one of:
processor utilization, memory consumption, user interactions, or data transmitted associated with the user device.

6. The method of claim 1, wherein sending control signals includes:
sending control signals to a perimeter system to cause the perimeter system to modify configurations associated with the network.

7. The method of claim 1, wherein sending control signals includes:
sending control signals to the network service system to cause the network service system to limit access by the user device to services provided by the network service system.

8. The method of claim 1, wherein sending control signals includes:
sending control signals to the network service system to cause the network service system to terminate an authenticated session involving the user.

9. The method of claim 1, wherein the user device is a first user device, wherein the control signals are a first set of control signals, and wherein the method further comprises:
receiving, by the computing system and over the network from a second user device, a third set of fingerprint data, wherein the third set of fingerprint data reflects operations performed by the second user device;
generating, by the computing system and based on the third set of fingerprint data, a threat assessment associated with the user of the second user device; and
sending, by the computing system and based on the threat assessment associated with the user of the second user device, a second set of control signals over the network.

10. The method of claim 1,
wherein the user device is a mobile device executing a mobile device application configured to collect fingerprint data.

11. The method of claim 1,
wherein the user device is a computing system executing a browser configured to collect fingerprint data by an application executing within the browser.

12. The method of claim 1,
wherein the user device is a computing system executing a native desktop application capable of interacting with an operating system executing on the computing system to collect the first set of fingerprint data.

13. A computing system comprising processing circuitry and a storage device, wherein the processing circuitry has access to the storage device and is configured to:
receive, over a network from a user device, a first set of fingerprint data, wherein the first set of fingerprint data reflects operations performed by the user device before a network service system authenticates a user of the user device;
generate, based on the first set of fingerprint data, a first threat assessment associated with the user;
receive, over the network from the user device, a second set of fingerprint data, wherein the second set of fingerprint data reflects operations performed by the user device after the network service system authenticates the user of the user device;
generate, based on the first set of fingerprint data and the second set of fingerprint data, a second threat assessment; and
send, based on the second threat assessment, control signals to a system on the network to cause the system to implement a threat mitigation policy.

14. The computing system of claim 13,
wherein the first set of fingerprint data includes information about startup processes performed by an application executing on the user device; and
wherein the second set of fingerprint data includes information about functions performed during an authenticated session by the application executing on the user device.

15. The computing system of claim 13, wherein the processing circuitry is further configured to:
determine, prior to generating the second threat assessment, that the user has been authenticated by the network service system.

16. The computing system of claim 13,
wherein the first set of fingerprint data includes information about at least one of:
processor utilization, memory consumption, user interactions, or data transmitted associated with the user device.

17. The computing system of claim 13, wherein to send control signals, the processing circuitry is further configured to:
send control signals to a perimeter system to cause the perimeter system to modify configurations associated with the network.

18. The computing system of claim 13, wherein to send control signals, the processing circuitry is further configured to:
send control signals to the network service system to cause the network service system to limit access by the user device to services provided by the network service system.

19. The computing system of claim 13, wherein to send control signals, the processing circuitry is further configured to:
send control signals to the network service system to cause the network service system to terminate an authenticated session involving the user.

20. Non-transitory computer-readable media comprising instructions that, when executed, cause processing circuitry of a computing system to:
receive, over a network from a user device, a first set of fingerprint data, wherein the first set of fingerprint data reflects operations performed by the user device before a network service system authenticates a user of the user device;
generate, based on the first set of fingerprint data, a first threat assessment associated with the user;
receive, over the network from the user device, a second set of fingerprint data, wherein the second set of fingerprint data reflects operations performed by the user device after the network service system authenticates the user of the user device;
generate, based on the first set of fingerprint data and the second set of fingerprint data, a second threat assessment; and
send, based on the second threat assessment, control signals to a system on the network to cause the system to implement a threat mitigation policy.
